(19) United States
(12) Patent Application Publication
(10) Pub. No.: US 2019/0017832 A1
(43) Pub. Date: Jan. 17, 2019

(54) METHOD AND APPARATUS FOR PROVIDING RECORDED, ANONYMIZED ROUTES

(71) Applicant: Siemens Aktiengesellschaft, München (DE)

(72) Inventor: Jens-Uwe Busser, Neubiberg (DE)

(21) Appl. No.: 16/068,977

(22) PCT Filed: Nov. 15, 2016
(86) PCT No.: PCT/EP2016/077663

§ 371 Date: Jul. 10, 2018

(30) Foreign Application Priority Data
Jan. 21, 2016 (DE) 10 2016 200 855.2

(51) Int. Cl. G01C 21/28; H04W 4/029; G08G 1/01; G06F 17/30

(52) U.S. Cl. CPC G01C 21/28; H04W 4/029; G08G 1/0112; G01C 21/3492; G08G 1/0141; G06F 17/30241; G08G 1/0129

(57) ABSTRACT

A method for providing recorded anonymized routes, wherein a route is a spatial movement of an object from a starting point to a destination point via successive waypoints, which movement is recorded by means of a position indication for each waypoint and is anonymized by removing object-identifying data, having the steps of: capturing more than one route, wherein each captured route has at least one waypoint or at least one overlapping partial route of adjacent waypoints in common with at least one other captured route, segmenting each route into at least two partial routes comprising at least one overlapping partial route or a common waypoint, storing each individual partial route of each captured route in a single data record for each partial route, and outputting the captured routes only in the form of the partial-route-specific data records. In addition, an apparatus which carries out the method.

### CROSS-REFERENCE TO RELATED APPLICATIONS

This application claims priority to PCT Application No. PCT/EP2016/077663, having a filing date of Nov. 15, 2016, based off of German application No. 102016200855.2 having a filing date of Jan. 21, 2016, the entire contents of both of which are hereby incorporated by reference.

### FIELD OF TECHNOLOGY

The following relates to a method and an apparatus for providing recorded, anonymized routes, wherein a route contains a series of position indications for waypoints and is anonymized by removing object-identifying data.

### BACKGROUND

The spatial movement of an object from a starting point to a destination point via successive waypoints is referred to as a route. In this case, a user, for example a natural person, is usually assigned to an object. In order to track the spatial movement of an object or a person, also called geo-tracking, there are by now a multiplicity of data sources. Such routes are recorded, for example, using GPS positioning of a smartphone, a tablet, a laptop or a navigation system belonging to a user or vehicle. Further data sources are radio cell positioning of a mobile phone by a mobile radio network operator or contact with WLAN or Bluetooth access points. A position indication or whereabouts of an object can likewise be captured when using electronic payment systems and cash machines by means of a credit or customer card. Electronic tickets or RFID cards can also be used to determine a route when used in public means of transport or when shopping.

In the case of GPS data, position indications are described by a geographical length and width indication and possibly height indications. In this case, different formats, for example a GPS exchange format, a geography markup language (GML) format or else a keyhole markup language (KML) format, are conventional. In addition to the position indications, time indications or time stamps are recorded for a route or else for individual waypoints. Data relating to the object itself or to the user of the located object are usually also stored for a route. These are, for example, a license plate of a vehicle, a telephone number, an IP address of a mobile radio device or else card numbers or master data of a credit card.

The recorded routes may be very useful for providing innovative services, for example traffic jam reports, rail traffic delays or suggestions of nearby catering facilities, or else for determining and predicting utilization of means of transport, for detecting traffic jams early and for avoiding traffic jams.

However, this information relating to routes covered by an object under consideration (vehicle, smartphone, etc.) also makes it possible to make statements on the behavior of the associated person and his personal preferences and characteristics. Therefore, these data are classified as personal or person-related and therefore possibly even as particularly sensitive data according to data protection law. Personal or person-related data can only be captured, processed or stored in some countries on the basis of a dedicated legal basis or a qualified declaration of consent by the person in question. However, if these data are successfully anonymized with the consent of the person in question, with the result that a reference to persons can no longer be established, these data are no longer regarded as personal or person-related and the restrictions from the data protection law are dispensed with for further uses of the data.

During anonymization, at least generally known data and pseudonyms identifying persons, for example an IP address or device identifier, are usually removed. Extensive information relating to the person may sometimes already be pulled from a starting or end point of a route and the number of possible persons for this route can therefore be very highly restricted. So-called de-anonymization of the route is therefore possible despite removing person-identifying or object-identifying data. Use of such route data would therefore still require a qualified declaration of consent to be obtained from all persons in question for each new intended purpose, but this usually cannot be carried out with reasonable effort. A multiplicity of recorded routes would therefore be excluded from further processing.

DE 10 2011 106 295 A1 discloses a method for bidirectionally transmitting information data between motor vehicles and a service provider. Before the information data are transmitted to the service provider, the information data are anonymized by means of a back-end server apparatus. In this case, waypoints within a particular time or distance from the starting and destination points of a journey of a respective vehicle are not passed on to the service provider in order to protect them as locations which can be assigned to a motor vehicle.

US 2013/006517 A1 describes a method for providing routes. In the event of a navigation request from a point A to a point B, an existing route is searched for in a database. If no such route is available, a route is determined from existing partial routes which correspond to the route searched for, at least in sections.

US 2015/308848 A1 describes a navigation system in which stored route data are anonymized by removing end regions.

### SUMMARY

An aspect relates to providing a method and an apparatus which prevent or at least hamper de-anonymization of route data and therefore make it possible to use said route data for further processing.

The method according to embodiments of the invention for providing recorded, anonymized routes, wherein a route is a spatial movement of an object from a starting point to a destination point via successive waypoints, which movement is recorded by means of a position indication for each waypoint and is anonymized by removing object-identifying data, has the following steps of:

capturing more than one route, wherein each captured route has at least one waypoint or at least one overlapping partial route of adjacent waypoints in common with at least one other captured route, segmenting each route into at least two partial routes comprising at least one overlapping partial route or a common waypoint, storing each individual partial route of each captured route in a single data record for each partial route, and outputting the captured routes only in the form of the partial-route-specific data records.

This has the advantage that an assignment of a starting point and a destination point to a route is therefore prevented or at least considerably hampered. The more routes with an overlapping stretch which are combined using the method, the more difficult it becomes to assign the partial routes to separate starting and end points. This is the case, in particular, when the overlapping partial route is briefly related to the overall route.

In one advantageous embodiment, overlapping partial routes of different routes are stored in a common data record.

This makes it possible to reduce the storage capacity for storing the captured routes since position indications for overlapping partial routes must be stored only once.

In one advantageous embodiment, a captured route which corresponds to the other routes only in one waypoint is segmented into two partial routes at the common waypoint. This makes it possible to increase the number of routes which are combined by means of the method. This also increases the number of possible combinations of partial routes for reconstructing an overall route, thus achieving better protection against de-anonymization.

In one advantageous embodiment, a captured time indication for a route, a partial route or a waypoint is rounded or is replaced with the indication of a time interval, and the rounding accuracy or the width of the time interval is selected in such a manner that a predefined minimum number of routes, partial routes or waypoints is captured in the time interval.

This has the advantage that it is difficult to assign associated partial routes using the time indications for the partial routes. In the case of a time indication for the partial routes which is captured with sufficient accuracy, associated adjacent partial routes could be determined and the overall route could therefore be determined.

In one variant, the captured time indications for a partial route or a waypoint are deleted.

Therefore, the overall route cannot be reconstructed by correlating the time indications for the partial routes or waypoints.

In another variant, captured time indications are replaced with indications of the time intervals only at waypoints in the region of segmentation points or only the time indications for the segmentation points are deleted.

In this case, a segmentation point is the end point of a partial route which is adjoined by an adjacent partial route. It is therefore difficult to assign adjacent partial routes to an overall route by correlating the time indications at the segmentation points. In this case, accurate time indications can also be provided for further evaluation, in particular in the case of longer partial routes.

In one advantageous embodiment, the accuracy of the position indications for waypoints in the region of a segmentation point is reduced, or waypoints in the region of a segmentation point are removed.

This also makes it difficult to assign partial routes to a recorded overall route. In this case too, the accuracy of the position indication can be dynamically adapted to the number of routes which comprise such a partial route. If there is a sufficiently large number of partial routes with position indications in a confined spatial area, the accuracy of the position indication can be increased. In times of heavy traffic, a time indication accurate to a few seconds or a position indication accurate to a few meters is still possible, for example, and, in times of light traffic, the time indication must possibly be rounded to a time interval of a full hour or a position indication must possibly be rounded to several meters. Position or else time indications in the region of a segmentation point, for example an intersection or a T-junction of roads, should be removed from the routes if the route is captured so accurately that the turning direction or the selected lane can be discerned from the start or end of a partial route, for example.

In one advantageous embodiment, a route with an intermediate destination is captured as two independent routes.

This makes it possible to increase the number of routes with an overlapping area and to conceal actual starting and destination points by means of the fictitious starting and destination points of intermediate destinations.

In one advantageous embodiment, a route is recorded by means of GPS positioning or radio cell positioning or by means of contact with an access point of a network or by means of contact with electronic payment systems or by means of contact with near-field communication reading locations.

The apparatus according to embodiments of the invention for providing recorded anonymized routes, wherein a route is a spatial movement of an object from a starting point to a destination point via successive waypoints, which movement is recorded by means of a position indication for each waypoint and is anonymized by removing object-identifying data, comprises a capture unit which is designed to capture more than one route, wherein each captured route has at least one waypoint or at least one overlapping partial route of adjacent waypoints in common with at least one other captured route, a segmentation unit which is designed to segment each route into at least two partial routes comprising at least one overlapping partial route or a common waypoint, a storage unit which is designed to store each individual partial route of all captured routes in a data record for each partial route, and an output unit which is designed to output the captured routes only in the form of partial-route-specific data records for evaluation and/or control.

In one advantageous embodiment, overlapping partial routes of different routes are stored in a common data record in the storage unit.

In this case, the apparatus contains at least one microprocessor which provides said function. Each of the routes captured by the capture unit has a partial route in common with at least one other captured route. If three routes are captured, for example, and all three routes each have a particular partial route in common and if each of the three captured routes consists of two further partial routes which do not overlap one of the other two routes, seven data records are created in the storage unit, wherein one data record contains the data relating to waypoints of all three captured routes which belong to the overlapping partial route and the six further data records each contain waypoints for one of the further partial routes of the total of three routes.

In one advantageous embodiment, the segmentation unit is designed to segment a captured route, which corresponds to the other routes only in one waypoint, into two partial regions at the common waypoint.

The common waypoint is therefore also a segmentation point here which divides a route into two partial routes as a minimum.

In one variant, the segmentation unit is designed to replace a captured time indication for a route, a partial route or a waypoint by means of rounding or by indicating a time interval and to set up the rounding accuracy or width of the time interval in such a manner that a predefined minimum number of routes, partial routes or waypoints is captured in the time interval.

In another variant, the segmentation unit is designed to delete a captured time indication for a route, a partial route or a waypoint.

In one variant, the segmentation unit is designed to replace only captured time indications for waypoints in the region of the segmentation points with the indications of the time intervals or to delete them.

This reduces the ability to correlate the partial routes and also reduces the processing capacity in the segmentation unit.

In one variant, the segmentation unit is designed to reduce the accuracy of the position indications for the waypoints in the region of a segmentation point or to remove waypoints in the region of a segmentation point.

This means that a selected turning lane or turning direction, for example, can no longer be discerned and it is difficult to make an assignment to the next or preceding partial route.

In one variant, the capture unit is designed to capture a route with an intermediate destination as two independent routes.

Embodiments of the invention also claim a computer program product (non-transitory computer readable storage medium having instructions, which when executed by a processor, perform actions) which can be directly loaded into a microprocessor and comprises program code parts which are suitable for carrying out the steps of the method.

### BRIEF DESCRIPTION

Some of the embodiments will be described in detail, with reference to the following figures, wherein like designations denote like members, wherein:

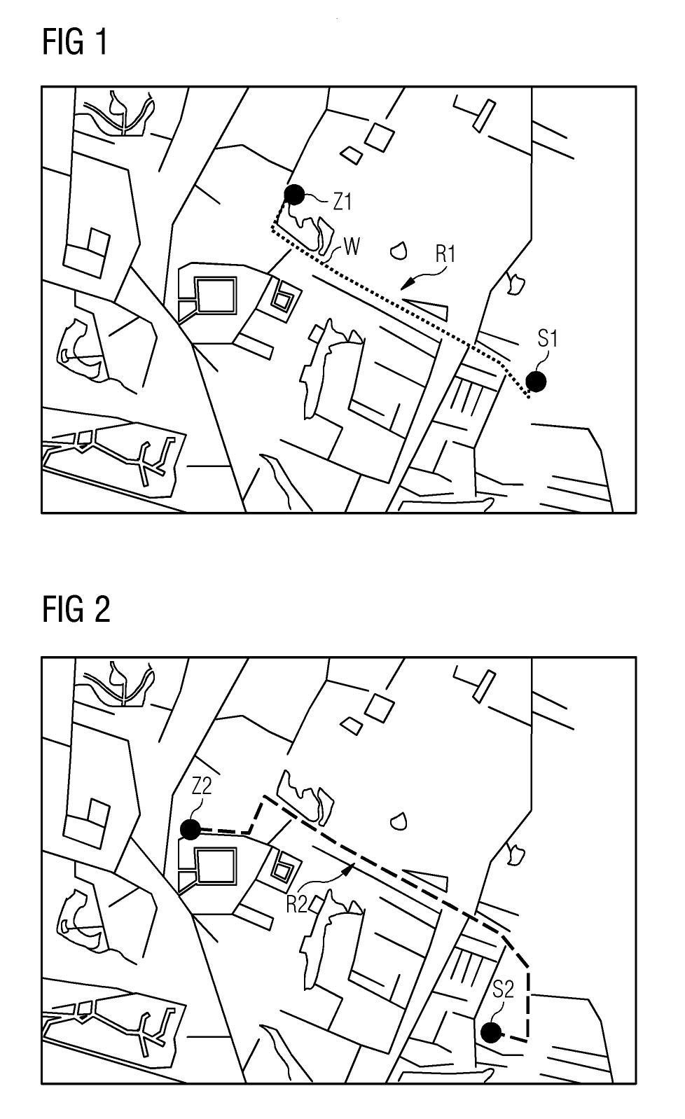

FIG. 1 shows a first exemplary route illustrated on part of a road map;

FIG. 2 shows a second exemplary route which has a partial route in common with the first route illustrated on part of a road map;

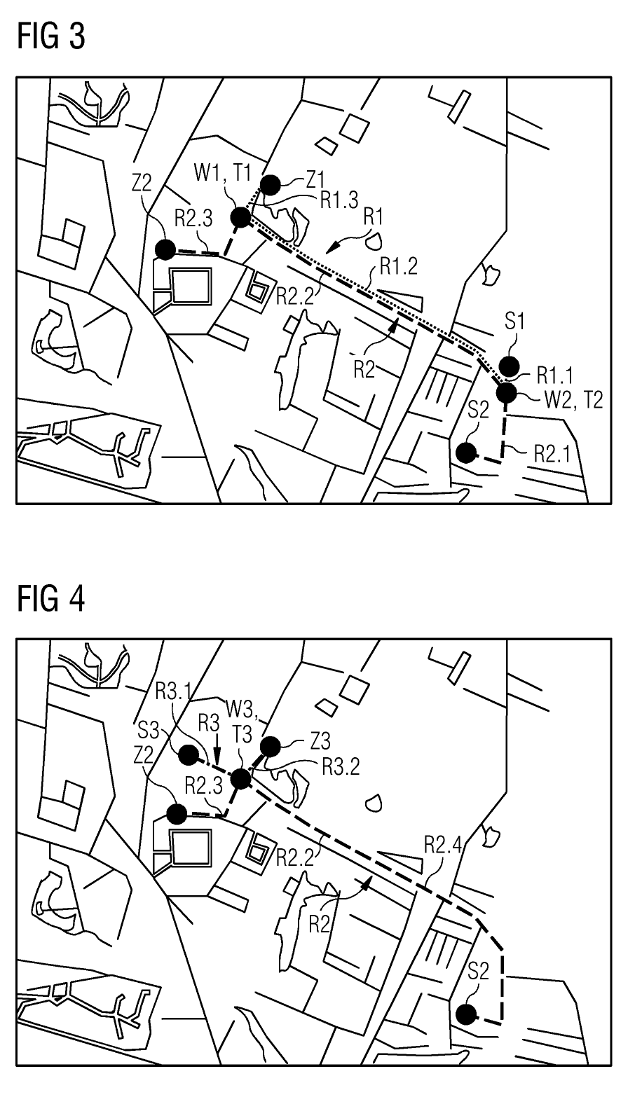

FIG. 3 shows the first and second routes broken down into partial routes illustrated together on part of a road map;

FIG. 4 shows the second and third routes broken down into partial routes illustrated together on part of a road map; and

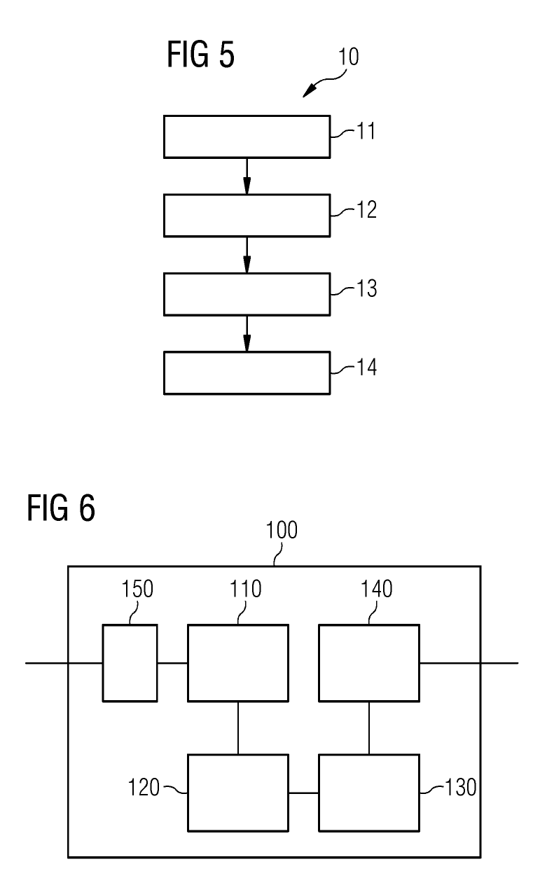

FIG. 5 shows an exemplary embodiment of the method in the form of a flowchart;

FIG. 6 shows an exemplary embodiment of an apparatus in a block diagram.

Parts which correspond to one another are provided with the same reference signs in all figures.

### DETAILED DESCRIPTION

FIG. 1 shows a first route R1 from a starting point S1 to a destination point Z1. In this case, the route covered is illustrated in a dotted manner. The dots represent waypoints W, for example, for which position indications and also time indications or height indications, for example, are respectively available. In order to use such a route R1 for further processing, either the person assigned to the moving object must give qualified, purpose-related consent to use the route data or the route data must be preprocessed in such a manner that it is impossible to draw conclusions with respect to the moving object or the user.

FIG. 2 illustrates a second route R2 having a starting point S2 and a destination point Z2 which each differ from the starting point S1 and the destination point Z1 of the first route R1. The route R2 covered between the starting point S2 and the destination point Z2 is depicted using dashed lines in FIG. 2.

FIG. 3 now shows the first and second routes R1, R2 together on a map. In this case, it is possible to discern an overlapping partial route R1.2, R2.2 between the waypoints W1 and W2. The method according to embodiments of the invention, illustrated in FIG. 5, is now described using the example of the first and second routes R1, R2 illustrated in FIG. 3.

In a first method step 11, the routes R1 and R2 are captured since they both comprise an overlapping partial route R1.2, R2.2 which extends between the waypoints W1 and W2. In a second method step 12, both routes R1 and R2 are now each broken down into three partial routes R1.1, R1.2, R1.3 and partial routes R2.1, R2.2 and R2.3, respectively, at the two identical waypoints W1 and W2 which are also referred to as segmentation points T1, T2. Both routes have the central section R1.2 and R2.2 in common. In method step 13, the data relating to the individual partial routes are now stored in a single data record for each differently running partial route. Five data records are therefore created. The partial route R1.1 is stored in a first data record. The partial route R2.1 is stored in a second data record. The partial route R1.2 and the partial route R2.2 are both stored together in a third data record. The partial route R1.3 is stored in a fourth data record and the partial route R2.3 is stored in a fifth data record. It is no longer clear whether the object 1 or an associated person has moved from the starting point S1 to the destination point Z1 or Z2. In a method step 14, the route data can now be read from the partial-route-specific data records and processed further.

FIG. 4 illustrates a further example with two captured routes R2 and R3. The route R2 corresponds to the route illustrated in FIG. 2, and the route R3 extends from a starting point S3 to a destination point Z3 and has only one waypoint W3 in common with the route R2. This can be a road intersection, for example. This common waypoint W3 is used as a segmentation point T3. The partial route of route R3 that overlaps route R2 therefore consists only of a single waypoint. Four partial routes are therefore produced. One partial route R2.4 extends between the starting point S2 and the common waypoint W3 of the route R2. A further partial route R2.3 extends between the common waypoint W3 and the destination point Z2. A third partial route R3.1 extends between the starting point S3 and the common waypoint W3. A fourth partial route R3.2 extends from the common waypoint W3 to the destination point Z3. Each of these partial routes R2.3, R2.4, R3.1, R3.2 is stored in a respective data record. The information relating to the captured routes is also output only in the form of the partial-route-specific data records here. The partial route R2.4 can alternatively also be broken down into a plurality of partial routes, for example R2.2 and R2.1 according to FIG. 3. Five data records are then accordingly generated and are output for further processing.

A segmentation point Ti is therefore a waypoint Wi which forms an end point of a partial route and is an element of at least two different partial routes. Intersections, T-junctions or highway exits in private transport, for example, are suitable as segmentation points. In the case of public means of transport, bus stops or rail stations, at which it is possible to get on and off, are particularly suitable. In order to prevent or hamper an assignment of different partial routes to an overall route, additional data such as meta data and user identifications, for example a device identifier, a telephone number or an IP address, must be removed. Partial de-anonymization by assigning starting and destination points to a route becomes all the more difficult, the more routes with overlapping partial routes are captured and are segmented and stored together.

Associated partial routes can also be assigned using the time if the partial routes have been captured with sufficient accuracy. Therefore, captured time indications for a route, a partial route or else individual waypoints are rounded or are replaced with the indication of a time interval. The rounding accuracy or width of the time interval, and therefore the accuracy of the time indication, is selected in this case in such a manner that a predefined minimum number of routes, partial routes or waypoints is captured in the time interval. Alternatively, the captured time indication can be fully removed. This should be carried out, in particular, in the vicinity of the segmentation points since the adjacent partial route can thus be assigned here. A similar assignment is possible when time indications at or in the vicinity of the segmentation points T1, T2 are stated with high accuracy. It could be possible to assign partial routes and therefore to determine the entire route by comparing the time indications for adjacent partial routes.

FIG. 6 illustrates an apparatus 100 according to embodiments of the invention which carry out the individual method steps of the method 10. The apparatus 100 comprises a capture unit 110, a segmentation unit 120, a storage unit 130 and an output unit 140. The apparatus 100 optionally comprises an anonymization unit 150 which removes object-identifying data before further processing in the capture unit 110. The apparatus 100 having the different units comprises one or more microprocessors which perform the corresponding actions. More than one route is captured in the capture unit 110, wherein each captured route has at least one waypoint or at least one overlapping partial route of adjacent waypoints in common with at least one other captured route. In this case, a partial route may be formed, in the extreme case, from a single waypoint which is then used as the segmentation point. The routes captured and determined by the capture unit 110 are forwarded to the segmentation unit 120. The segmentation unit 120 segments each route into at least two partial routes, wherein each partial route has at least one common waypoint as the segmentation point.

The data relating to each waypoint are now stored in a data record for each partial route in the storage unit 130. It is particularly favorable if overlapping partial routes of different routes are stored in a common data record. The storage unit 130 therefore comprises precisely one data record for each route from a first segmentation point to a second segmentation point. As a result, the partial route also cannot be subsequently assigned to any particular route.

The output unit 140 outputs the route data only in the form of one, a plurality of or all data records. If these data are analyzed in a post-processing apparatus, it is scarcely possible to correlate the individual partial routes with a complete route. Therefore, there are no reservations in terms of data protection law with respect to the further processing.

All features described and/or shown can be advantageously combined with one another within the scope of embodiments of the invention. Embodiments of the invention are not restricted to the exemplary embodiments described.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for providing recorded anonymized routes, wherein a route is a spatial movement of an object from a starting point to a destination point via successive waypoints, which movement is recorded by means of a position indication for each waypoint and is anonymized by removing object-identifying data, having the steps of:
capturing more than one route, wherein each captured route has at least one waypoint or at least one overlapping partial route of adjacent waypoints in common with at least one other captured route,
segmenting each route into at least two partial routes comprising at least one overlapping partial route or a common waypoint, and
storing each individual partial route of each captured route in a single data record for each partial route, outputting all captured routes together in the form of partial-route-specific data records.

2. The method as claimed in claim 1, wherein overlapping partial routes of different routes are stored in a common data record.

3. The method as claimed in claim 1, wherein a captured route which corresponds to the other routes only in one waypoint is segmented into two partial routes at the common waypoint.

4. The method as claimed in claim 1, wherein a captured time indication for a route, a partial route or a waypoint is rounded or is replaced with the indication of a time interval, and the rounding accuracy or the width of the time interval is selected in such a manner that a predefined minimum number of routes, partial routes or waypoints is captured in the time interval.

5. The method as claimed in claim 1, wherein the captured time indications for a route, a partial route or a waypoint are deleted.

6. The method as claimed in claim 4, wherein the captured time indications are replaced with indications of the time intervals or are deleted only at waypoints in the region of segmentation points of a partial route.

7. The method as claimed in claim 1, wherein the accuracy of the position indications for waypoints in the region of a segmentation point is reduced, or waypoints in the region of a segmentation point are removed.

8. The method as claimed in claim 1, wherein a route with an intermediate destination is captured as two independent routes.

9. The method as claimed in claim 1, wherein a route is recorded by means of GPS positioning or radio cell positioning or by means of contact with an access point of a network or by means of contact with electronic payment systems or by means of contact with near-field communication reading locations.

10. An apparatus for providing recorded anonymized routes, wherein a route is a spatial movement of an object from a starting point to a destination point via successive waypoints, which movement is recorded by means of a position indication for each waypoint and is anonymized by removing object-identifying data, comprising:
a capture unit which is designed to capture more than one route, wherein each captured route has at least one waypoint or at least one overlapping partial route of adjacent waypoints in common with at least one other captured route,
a segmentation unit which is designed to segment each route into at least two partial routes comprising at least one overlapping partial route or a common waypoint,
a storage unit which is designed to store each individual partial route of each captured route in a single data record for each partial route, and an output unit which is designed to output the captured routes only in the form of the partial-route-specific data records for evaluation and/or control.

11. The apparatus as claimed in claim 10, wherein overlapping partial routes of different routes are stored in a common data record.

12. The apparatus as claimed in claim 10, wherein the segmentation unit is designed to segment a captured route, which corresponds to the other routes only in one waypoint, into two partial regions at the common waypoint.

13. The apparatus as claimed in claim 10, wherein the segmentation unit is designed to round a captured time indication for a route, a partial route or a waypoint or to replace it with the indication of a time interval and to set up the rounding accuracy or width of the time interval in such a manner that a predefined minimum number of routes, partial routes or waypoints is captured in the time interval.

14. The apparatus as claimed in claim 10, wherein the segmentation unit is designed to delete a captured time indication for a route, a partial route or a waypoint.

15. The apparatus as claimed in claim 13, wherein the segmentation unit is designed to replace only captured time indications for waypoints in the region of a segmentation point with an indication of the time intervals or to delete them.

16. The apparatus as claimed in claim 10, wherein the segmentation unit is designed to reduce the accuracy of the position indications for waypoints in the region of a segmentation point or to remove waypoints in the region of a segmentation point.

17. The apparatus as claimed in claim 10, wherein the capture unit is designed to capture a route with an intermediate destination as two independent routes.

18. A computer program product comprising a computer readable hardware storage device having computer readable program code stored therein, said program code executable by a processor of a computer system to implement a method which can be loaded into a microprocessor, comprising program code parts which are suitable for carrying out the steps of the method as claimed in claim 1.
